(19) United States
(12) Patent Application Publication
(10) Pub. No.: US 2021/0214654 A1
(43) Pub. Date: Jul. 15, 2021

(54) COFFEE GRINDER CLEANER

(71) Applicant: ECOLAB USA INC., Saint Paul, MN (US)

(72) Inventor: Thomas J. Vinson, Saint Paul, MN (US)

(21) Appl. No.: 17/248,033

(22) Filed: Jan. 6, 2021

Related U.S. Application Data
(60) Provisional application No. 62/959,247, filed on Jan. 10, 2020.

(51) Int. Cl. C11D 7/12; C11D 11/00; C11D 17/06; C11D 7/44

(52) U.S. Cl. CPC C11D 7/12; C11D 7/44; C11D 17/06; C11D 11/0041

(57) ABSTRACT

Solid coffee grinder cleaning compositions made from all-natural, biodegradable components are provided. Beneficially, the cleaning compositions remove coffee oils and residues from grinders without requiring grinder disassembly and/or extensive production processes. Methods for cleaning coffee and espresso grinders are also provided.

### CROSS-REFERENCE TO RELATED APPLICATION

This application claims priority under 35 U.S.C. § 119 to Provisional Application U.S. Ser. No. 62/959,247, filed on Jan. 10, 2020, which is herein incorporated by reference in its entirety including without limitation, the specification, claims, and abstract, as well as any figures, tables, or examples thereof.

### FIELD OF THE INVENTION

The invention relates to coffee grinder cleaning compositions for safe all-natural, biodegradable cleaning solutions for coffee and espresso grinders. The cleaning compositions remove coffee soils, residues and oils from various types of grinders without requiring grinder disassembly and/or extensive production processes. Methods for cleaning coffee and espresso grinders are also provided.

### BACKGROUND OF THE INVENTION

Grinding machines for coffee and espresso are widely used in consumer and commercial settings. There has been a significant increase in the popularity of fresh-ground coffee and specialty beverage markets that use grinders for brewing coffee and espresso. These drinks require clean grinders and brewing equipment to provide consistent quality and taste of the beverage. The equipment cleanliness, namely the grinders for grinder the beans, is a critical step in the process as the whole coffee beans are processed through the grinders before they are brewed. Often the whole coffee beans are first roasted to enhance the flavor of the brewed coffee. The roasting process releases oils from the beans before they are ground for brewing to extrude the maximum amount of coffee oils during the brewing process. The taste profile of the brewed coffee can be negatively impacted if there is contamination in the grinder, such as from old or rancid coffee oils, soils and other residues that are insufficiently cleaned from the grinder.

Various methods and compositions for cleaning the grinders are used, including grinding grains, beans and other materials to remove oils and residues from the grinder burs and castings. A limitation of available cleaners for grinders are that they often cause blockages between burrs (i.e. grinding blades) and internal chambers of the grinders. This causes significant disruption as it often requires disassembly of the grinder. It can also hinder the grinding performance overtime by damaging the burrs.

There are also insufficient options for cleaning compositions that are all-natural biodegradable formulas. Moreover, various cleaning compositions can include components that impart an unfavorable residue or off-taste that lingers with the grinder and can be imparting to subsequent coffee that is ground. There is therefore a consumer and commercial demand for improved coffee grinder cleaning compositions and methods of using the same.

It is therefore an object of this disclosure to provide all-natural biodegradable coffee grinder cleaning compositions.

It is a further object of the disclosure to provide coffee grinder cleaning compositions of a desired particle size of the granules that do not jam, clog, block or otherwise damage the burrs and/or castings of a grinder.

Other objects, aspects and advantages of this invention will be apparent to one skilled in the art in view of the following disclosure, the drawings, and the appended claims.

### SUMMARY OF THE INVENTION

An advantage of the coffee grinder cleaning compositions and methods of using the same is that they provide all-natural biodegradable cleaning options that do not jam, block or otherwise damage the burrs and/or castings of a grinder.

In an embodiment a method of cleaning a coffee and/or espresso grinder comprises adding a coffee grinder cleaning composition to a coffee and/or espresso grinder soiled with oils and/or other residue from grinding coffee and/or espresso, wherein the cleaning composition comprises a food-safe organic material comprising from about 50 wt-% to about 95 wt-% and a carbonate source comprising from about 5 wt-% to about 50 wt-%, wherein the composition are granules having an average particle size between about 3 mm to about 5 mm; grinding the coffee grinder cleaning composition in the grinder; removing the ground coffee grinder cleaning composition; and optionally adding stale coffee beans to the coffee grinder and grinding the stale coffee beans for a sufficient period of time to remove any residue from the cleaning composition.

In further embodiments, the cleaning composition does not jam, clog, block or otherwise damage the burrs and/or castings of the grinder. In further embodiments, the grinder is a conical burr grinder or a flat burr grinder, and beneficially the cleaning composition removes blockages between the burrs and internal chambers of the grinder. In still further embodiments, the cleaning composition does not impart any residue and/or off-taste to the grinder after cleaning, and/or the cleaning composition improves grinding performance of the grinder after cleaning. Still further according to the embodiments, the methods do not include disassembly of the grinder and/or use of any liquids and/or fragrance.

In additional embodiments, coffee grinder cleaning compositions comprise, consist of and/or consist essentially of from about 50 wt-% to about 95 wt-% of a food-safe organic material; and from about 5 wt-% to about 50 wt-% of a carbonate source; wherein the composition are granules having an average particle size between about 3 mm to about 5 mm.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the evaluated granule sizes of the coffee grinder cleaning composition described in Example 1.

FIG. 2 shows the test results of Example 1 wherein the coffee grinder cleaning composition binds to the coffee oils and coffee grinds (residues) when cleaning a coffee grinder.

FIG. 3 shows the test results of Example 2 evaluating a coffee grinder cleaning composition in a conical burr grinder compared to a flat burr grinder, including before and after cleaning images.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION OF THE PREFERRED EMBODIMENTS

The embodiments are not limited to particular methods of using the coffee grinder cleaning compositions, which can vary and are understood by skilled artisans. It has been surprisingly found that the coffee grinder cleaning compositions and methods of using the same is that they provide all-natural biodegradable cleaning options that do not jam, block or otherwise damage the burrs and/or castings of a grinder.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form. Numeric ranges recited within the specification are inclusive of the numbers within the defined range. Throughout this disclosure, various aspects are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments without undue experimentation, but the preferred materials and methods are described herein. In describing and claiming the embodiments, the following terminology will be used in accordance with the definitions set out below.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

As used herein, the term “free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

The methods and compositions may comprise, consist essentially of, or consist of the components and ingredients as well as other ingredients described herein. As used herein, “consisting essentially of” means that the methods and compositions may include additional steps, components or ingredients, but only if the additional steps, components or ingredients do not materially alter the basic and novel characteristics of the claimed methods and compositions.

Coffee Grinder Cleaning Compositions

According to embodiments, the coffee grinder cleaning compositions include all-natural biodegradable cleaning components that do not impart residues or off-tastes onto the coffee grinders. Exemplary coffee grinder cleaning compositions are shown in Table 1 in weight percentage.

TABLE 1

| | First | Second | Third | Fourth |
|---|---|---|---|---|
| | Exemplary | Exemplary | Exemplary | Exemplary |
| Material | Range wt.-% | Range wt.-% | Range wt.-% | Range wt.-% |
| Organic | 50-95 | 50-90 | 60-90 | 80-90 |
| Material | | | | |
| Bicarbonate | 5-50 | 10-50 | 10-40 | 10-20 |
| Source | | | | |
| Additional | 0-50 | 0-25 | 0-10 | 0 |
| Functional | | | | |
| Ingredients | | | | |

The coffee grinder cleaning compositions are provided as granules having an average particle size of between about 3 mm to about 5 mm. The granules are preferably a substantially uniform size such that there is minimal variation in the size of the granules. The methods described herein benefit from the granule size between about 3 mm to about 5 mm as the cleaning composition does not jam, clog, block or otherwise damage the burrs and/or castings of a grinder. There is a benefit of the cleaning compositions provided as 3 mm to about 5 mm granules as opposed to smaller fine granules less than 3 mm as the smaller sized compositions often jam or clog up the burrs during the grinding phase of the cleaning methods. There is a benefit of using granules which will allow the cleaning process to be performed using less product of <30 grams per cleaning.

The cleaning compositions can be ground into the desired granule size by any methods known to those skilled in the art. Before the grinding or pelletizing of the cleaning composition to provide the desired granule size, the cleaning composition can be formed into a solid by any methods known in the art, including for example pressing, molding, casting or the like. However, in preferred embodiments the solid compositions are made by addition of the components of the cleaning composition which are in a solid form and optionally adding a binder (e.g. glycerin).

Organic Material

The coffee grinder cleaning compositions includes an organic material. Organic materials can vary based on availability in different parts of the world. Exemplary organic materials include, for example, grains, cereals, grasses, legumes, nuts and shells thereof, fibers, fruit skins, and the like. Exemplary grains include maize (i.e. corn husks, corn meal), sorghum, quinoa, oats, buckwheat, amaranth, seeds from wheat and bulgur wheat, and rice (i.e. brown, white, wild). Exemplary grasses include wheat. Various additional seeds from grasses are included in organic materials, including rice and rice hulls. Exemplary fruit skins include banana peels, which can be dried and used in the compositions herein.

In some embodiments, the organic material is included in the cleaning composition at an amount from about 50 wt-% to about 95 wt-%, about 50 wt-% to about 90 wt-%, about 60 wt-% to about 90 wt-%, about 70 wt-% to about 90 wt-%, or about 80 wt-% to about 90 wt-%. In other embodiments, the organic material is included in the cleaning composition at an amount from about 70 wt-% to about 95 wt-%, about 80 wt-% to about 95 wt-%, or about 80 wt-% to about 90 wt-%. In addition, without being limited according to the invention, all ranges recited are inclusive of the numbers defining the range and include each integer within the defined range.

Bicarbonate Source

The coffee grinder cleaning compositions includes a bicarbonate source. Exemplary bicarbonate sources can include, for example, an alkali metal bicarbonate or carbonate source. A preferred bicarbonate is sodium bicarbonate. Without being limited to a mechanism of action, the bicarbonate source in the cleaning compositions aids to absorb oils and residues on the soiled grinder surfaces that provides superior efficacy in comparison to cleaning agents that only contain organic materials.

In some embodiments, the bicarbonate source is included in the cleaning composition at an amount from about 5 wt-% to about 50 wt-%, about 10 wt-% to about 50 wt-%, or about 10 wt-% to about 30 wt-%. In other embodiments, the bicarbonate source is included in the cleaning composition at an amount from about 5 wt-% to about 20 wt-%, or from about 10 wt-% to about 20 wt-%. In addition, without being limited according to the invention, all ranges recited are inclusive of the numbers defining the range and include each integer within the defined range.

Additional Functional Ingredients

The components of the coffee grinder cleaning composition can further be combined with various functional components suitable for uses disclosed herein. In some embodiments, the cleaning composition including the organic material and bicarbonate source, make up a large amount, or even substantially all of the total weight of the cleaning compositions. In some embodiments few additional functional ingredients are disposed therein. In preferred embodiments no additional functional ingredients are disposed therein.

In other embodiments, additional functional ingredients may be included in the cleaning compositions. The functional ingredients provide desired properties and functionalities to the compositions. For the purpose of this application, the term “functional ingredient” includes a material that when dispersed in the granules (and/or ground with the granules) to provide a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning and/or materials used in forming stable granules.

In some embodiments, the cleaning compositions may include binding agents, colorants, anti-redeposition agents, dispersants, aesthetic enhancing agents, additional rheology and/or solubility modifiers or thickeners, hydrotropes or couplers, buffers, and the like. Exemplary binding agents can include, for example, alcohols, glycols and/or glycerins, or other food safe pharmaceutical binders.

According to embodiments of the invention, the various additional functional ingredients may be provided in a composition in the amount from about 0 wt-% and about 50 wt-%, from about 0 wt-% and about 25 wt-%, from about 0 wt-% and about 10 wt-%, from about 0.01 wt-% and about 50 wt-%, from about 0.1 wt-% and about 25 wt-%, or from about 1 wt-% and about 10 wt-%. In addition, without being limited according to the invention, all ranges recited are inclusive of the numbers defining the range and include each integer within the defined range.

Methods of Cleaning

The coffee grinder cleaning compositions are suited for cleaning a variety of coffee and/or espresso grinders, including either freestanding or integrated grinding systems. Reference to coffee does not in any way limit the use of espresso or other types of coffee beans for cleaning according to the methods described herein. Exemplary grinders commercially available are made by Dining, Mahlkonig, FRANKE, Schaerer, Grindmaster, and the like. The coffee grinder cleaning composition are suitable for use in both conical burr grinders and flat burr grinders. Beneficially, the use of the coffee grinder cleaning compositions does not damage the burrs and/or castings of the grinders.

If needed, the methods can first include a step of removing from the grinder any whole bean coffee and/or ground residues. In embodiments this is achieved by simply running the grinder until it is empty, according to the grinder specifications.

The methods include first adding a coffee grinder cleaning composition to a coffee and/or espresso grinder soiled with oils and/or other residue from grinding coffee and/or espresso. The adding of the coffee grinder composition further removes any flavors that may distinct to coffee oils on the surfaces in need of cleaning, such as from use of flavored coffees that have infused essential oils and flavorings (e.g. vanilla and hazelnut). The cleaning composition is added to the same spot as the coffee beans that are ground therein, for example, the coffee bean hopper.

In an embodiment, the coffee grinder cleaning composition is added in an amount of at least about 10 grams, at least about 15 grams, at least about 30 grams, at least about 45 grams, or at least about 60 grams In a preferred embodiment, the coffee grinder cleaning composition is added in an amount of about 30 grams or less, in an amount of about 10 to about 30 grams, or in an amount of about 10 to about 20 grams. As one skilled in the art will ascertain from the description and examples provided herein, the type and size of the grinder, as well as the amount of soiling and residue and/or oils in the grinder, will dictate the amount of the coffee grinder cleaning composition required for the methods of cleaning. However, it is a benefit of the methods described herein that a low level of actives or amount of the cleaning compositions are required due to the improved cleaning performance achieved by the coffee grinder cleaning composition.

In some embodiments, the desired dose of the cleaning composition can be packaged or otherwise provided in what are considered to be unit dosages for the cleaning of particular grinders. In an exemplary embodiment, the cleaning composition can be provided in a cup or other packaging to added directly into the grinder once removed from the packaging, such as for example a 30 gram (or less) packet. The cleaning composition could also be provided in larger quantities, such that the desired amount is not individually packaged and is instead scooped or poured from a container to be dosed into the grinder.

The methods include a step of next grinding the coffee grinder cleaning composition in the grinder. The grinding step can last for about 30 seconds to about 3 minutes, which will vary based upon the settings for cleaning intervals of the particular grinder being cleaned. The grinding step runs the same as if the grinder were grinding coffee. The cleaning composition is then processed through the grinder, such that the soiled burrs, castings and/or internal chambers soiled with coffee residues and/or oils are cleaned. The cleaning composition removes the soils, residues and/or oils from the grinder as a result of the mechanical action and granule size of the cleaning composition. Without being limited to a particular mechanism of action, the components of the cleaning composition are provided as granules which provide abrasive surfaces for contacting the grinder, and as the granules are further ground within the grinder they cause the elimination of the soils, residues and oils through a first binding of the cleaning composition to such surfaces and then being pushed out of the grinder. The result of the method is that the coffee soils, residues and oils are removed or forced out of the grinder by the cleaning composition.

The cleaning step of grinding the cleaning composition can be repeated one or more times as needed based upon the type of coffee being ground, amount of time between cleaning intervals of the grinder, and the like. The methods also include a step of removing the ground coffee grinder cleaning composition from the grinder. The ground cleaning composition is removed through the same purging process that ground coffee is removed from the grinder. For example, fresh coffee beans can be added to the bean hopper and processed through the grinder to remove the ground cleaning composition. This step can be repeated any number of times to remove the ground cleaning composition.

Beneficially, the cleaning step effectively removes the build-up of any soils, residues and/or oils from the grinder. The cleaning step also removes any blockages within the grinder, such as between burrs and internal chambers. This cleaning effect is seen in the burrs, castings and any internal chambers in contact with the cleaning composition. As a result, the entirety of the surfaces in contact with coffee beans (and during the cleaning step the cleaning composition) are thoroughly cleaned such that no soils, residues and/or oils remain. Moreover, there are no residual residues and/or off-tastes imparted by the cleaning composition.

The methods include an optional step of adding stale coffee beans to the coffee grinder and grinding the stale coffee beans for a sufficient period of time to remove any residue from the cleaning composition.

The methods do not require any grinder disassembly and/or extensive production processes (e.g. brushing by hand the components of the grinder once disassembled) for cleaning providing a benefit to the user or operator. This is distinct from various known methods for cleaning to purge or remove oils and residues that accumulate in the grinder. The methods further do not require any processing with liquids (either added into the cleaning composition and/or added in the cleaning process directly to the grinder), which is a benefit due to the grinder made of steels or ceramics along with electrical motors in the grinder, where the use of liquids can damage the burrs and other components by rust and/or damaging the electrical components of the grinder. As a result of not requiring disassembly, extensive production processes and/or use of liquids, the methods of cleaning provided herein are neither time consuming nor complicated.

In an embodiment, the cleaning methods beneficially improve grinder performance.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following ingredients are utilized in the Examples:

Coffee Grinder Cleaning Composition: 83 wt-% Corn Husks, 17 wt-% Sodium Bicarbonate.

### Example 1

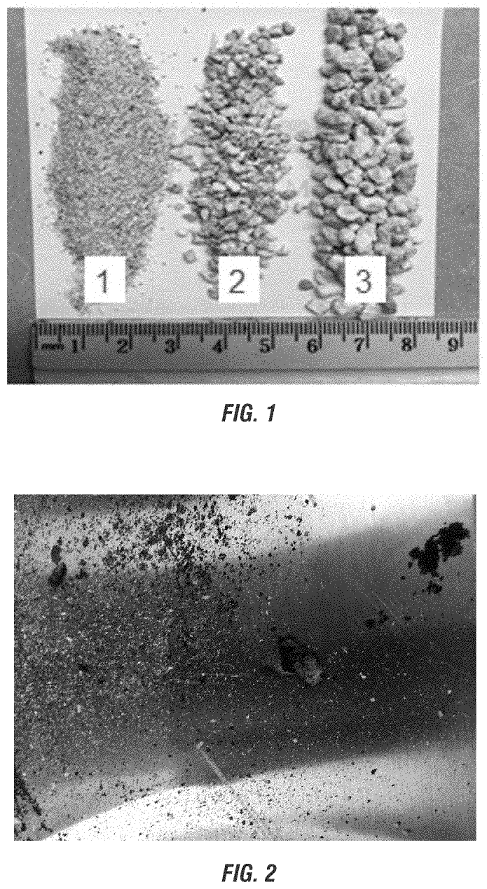

Three different granule sizes of the coffee grinder cleaning compositions were evaluated for performance in a coffee grinder as shown in FIG. 1. The figure is shown with a rule measuring in centimeters where 10 millimeters are equal to 1 centimeter. The sizes varied from 1 mm (Sample 1 in FIG. 1) to 5 mm (Sample 3 in FIG. 1 has sizes between 3-5 mm) in size, where the average optimal particle size of the granules was between about 3-5 mm range (Sample 3 in FIG. 1). The cleaning composition were ground using a Cuisinart® flat burr coffee grinder. The test evaluated the ability of the various sizes of the coffee grinder cleaning composition to process through the grinder without causing jams, clogs or other damage to the burrs.

FIG. 2 shows the results of cleaning using Sample 3 from FIG. 1 when cleaning the grinder. FIG. 2 shows that the cleaning composition binds to the coffee oils and coffee grinds (residues) to effectively clean the coffee grinder. Samples 1 and 2 (the smallest granule size) were ineffective in cleaning as the samples caused locking up of the grinder. In particular the samples<1 mm (Sample 1 in FIG. 1) jammed up the flat burr grinder due to the extrusion process to push the granules out during the grinding. This demonstrates that too fine a particle has undesirable effects, whereas the larger size does not cause these issues. The largest size of Sample 3 was effective to remove the oils and residue and showed no issues with the mechanical function of the grinder.

### Example 2

A coffee grinder cleaning composition was evaluated for performance in multiple types of coffee grinders, including flat burr and conical burr coffee grinders. The tests evaluated the ability of the coffee grinder cleaning composition to process through the grinder and effectively clean the grinder to remove soils, namely oils, from the machine and the burrs. The cleaning assessment is based on the complete removal of soils, namely oils, from the coffee grinder. Complete (100%) removal is required for efficacy. Two types of coffee grinders were used for one week without cleaning, such that coffee beans were ground for one week in each machine. An OXO® conical burr coffee grinder and a Cuisinart® flat burr coffee grinder were each evaluated. The following rating scale was used to assess cleaning efficacy compared to a commercial control:
Score 0—fails to clean due to jams, clogs or other damage to the burrs/equipment
Score 1-4—based on degree of cleaning but limited amount of jams, clogs or other damage to the burrs/equipment that prevent complete cleaning
Score 5—performs as desired with complete removal of soils and oils and no jams, clogs or other damage to the burrs/equipment

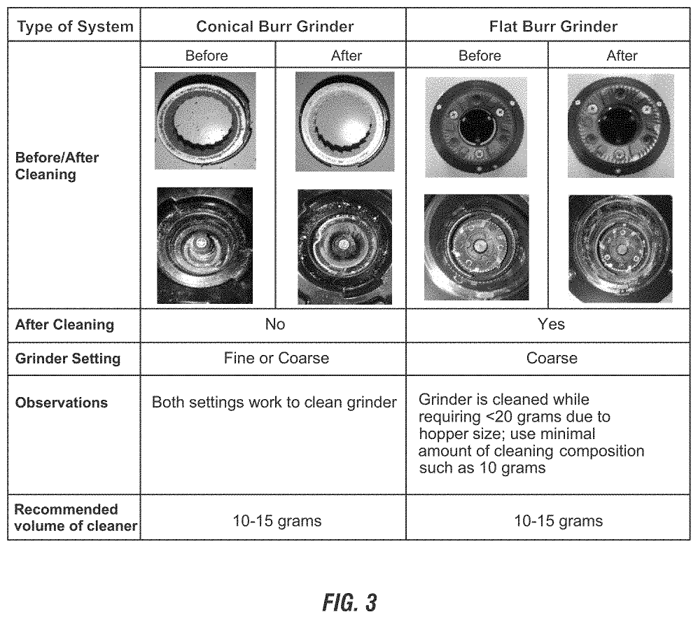

Before cleaning any remaining coffee beans were removed from the hopper. One scoop (approximately 30 grams) of the coffee grinder cleaning composition was poured into each coffee grinder, where the before and after cleaning images, grinder settings, and notes and observations of the test are shown in FIG. 3. As shown in the figure, “after cleaning” indicates image was taken after the coffee grinder product was used. The cleaning composition was ground through the grinder, and thereafter followed with stale coffee beans until all white residue was gone from the grinder.

As outlined in FIG. 3 the coffee grinder cleaning compositions effectively cleaned (i.e. removed oils) both types grinders demonstrating the utility and efficacy of the coffee grinder cleaning compositions.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. In addition, the contents of all patent publications discussed supra are incorporated in their entirety by this reference.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof

What is claimed is:

1. A method of cleaning a coffee and/or espresso grinder comprising:
adding a coffee grinder cleaning composition to a coffee and/or espresso grinder soiled with oils and/or other residue from grinding coffee and/or espresso, wherein the cleaning composition comprises a food-safe organic material comprising from about 50 wt-% to about 95 wt-% and a carbonate source comprising from about 5 wt-% to about 50 wt-%, wherein the composition are granules having an average particle size between about 3 mm to about 5 mm;
grinding the coffee grinder cleaning composition in the grinder;
removing the ground coffee grinder cleaning composition;
optionally adding stale coffee beans to the coffee grinder and grinding the stale coffee beans for a sufficient period of time to remove any residue from the cleaning composition.

2. The method of claim 1, wherein the cleaning composition does not jam, clog, block or otherwise damage the burrs and/or castings of the grinder.

3. The method of claim 1, wherein the grinder is a conical burr grinder or a flat burr grinder.

4. The method of claim 1, wherein the cleaning composition removes blockages between the burrs and internal chambers of the grinder.

5. The method of claim 1, wherein the cleaning composition does not impart any residue and/or off-taste to the grinder after cleaning.

6. The method of claim 1, wherein the cleaning composition improves grinding performance of the grinder after cleaning.

7. The method of claim 1, wherein the method does not include disassembly of the grinder.

8. The method of claim 1, wherein the method does not include use of any liquids.

9. The method of claim 1, wherein the cleaning composition does not include any fragrance.

10. The method of claim 1, wherein less than about 30 grams of the coffee grinder cleaning composition is added to the coffee and/or espresso grinder for cleaning.

11. The method of claim 10, wherein from about 10-30 grams of the coffee grinder cleaning composition is added to the coffee and/or espresso grinder for cleaning.

12. The method of claim 10, wherein from about 10-20 grams of the coffee grinder cleaning composition is added to the coffee and/or espresso grinder for cleaning.

13. A coffee grinder cleaning composition comprising:
from about 50 wt-% to about 95 wt-% of a food-safe organic material; and
from about 5 wt-% to about 50 wt-% of a carbonate source;
wherein the composition are granules having an average particle size between about 3 mm to about 5 mm.

14. The composition of claim 13, wherein the composition does not include any fragrance.

15. The composition of claim 13, wherein the composition granules are dosed in an amount less than about 30 grams for cleaning a coffee and/or espresso grinder.

16. The composition of claim 13, wherein the composition granules are dosed in an amount from about 10-30 grams for cleaning a coffee and/or espresso grinder.

17. The composition of claim 13, wherein the composition granules are dosed in an amount from about from about 10-20 grams for cleaning a coffee and/or espresso grinder.

18. A coffee grinder cleaning composition consisting essentially of:
from about 50 wt-% to about 95 wt-% of a food-safe organic material; and
from about 5 wt-% to about 50 wt-% of a carbonate source;
wherein the composition are granules having an average particle size between about 3 mm to about 5 mm.
